(19) United States
(12) Patent Application Publication
(10) Pub. No.: US 2017/0052984 A1
(43) Pub. Date: Feb. 23, 2017

(54) METHODS AND SYSTEMS FOR OPTIMIZING DATA IN LARGE DATA SETS USING RELEVANT METADATA

(71) Applicant: Adam Phillip Treiser, North Brunswick, NJ (US)

(72) Inventor: Adam Phillip Treiser, North Brunswick, NJ (US)

(21) Appl. No.: 15/305,946

(22) PCT Filed: Apr. 20, 2015
(86) PCT No.: PCT/US15/26649

§ 371 Date: Oct. 21, 2016

Related U.S. Application Data
(60) Provisional application No. 61/981,887, filed on Apr. 21, 2014.

(51) Int. Cl. G06F 17/30

(52) U.S. Cl. CPC G06F 17/30297; G06F 17/30867; G06F 17/30563

(57) ABSTRACT

Systems, computer-implemented methods, and non-transitory computer-readable media are provided for on-boarding client data received from multiple information sources. Consistent with the disclosed embodiments, a computer system may receive metadata concerning information received from one or more information sources. The computer system may receive instructions for mapping the information onto a schema of a trait-based modeling system. Based on these received instructions, the computer system may generate a script for on-boarding the client data. The computer system may provide the script to a server, which may execute the script, causing the resulting information to be provided to a trait-based modeling system to optimize a field in the schema of the trait-based modeling system.

This application claims the benefit of U.S. Provisional Application No. 61/981,887, filed Apr. 21, 2014, which is incorporated herein by reference in its entirety.

### TECHNICAL FIELD

The disclosed embodiments generally relate to the assisted onboarding of complex datasets. More specifically, example embodiments relate to graphical user interfaces configured for creating scripts that onboard multiple complex datasets into a cohesive single dataset used for predictive analytics.

### BACKGROUND

There is a growing trend among companies to use large quantities of information collected about customers and consumers. For example, such information may be analyzed to increase sales, through more efficient advertising. Companies advertise products online in a variety of different ways, including websites (e.g., social. media site, search engines, news sites), social media sites (e.g., Facebook, Twitter, instagram, Linkedin, Pinterest, tumblr, flickr, meetup), and online marketing platforms (e.g., Constant Contact, AWeber, Benchmark, BigHip, Boomerang, Compaigner, iContact, MailChimp). The focus of most companies is usually increasing sales or visibility of the company, by utilizing one or more of the aforementioned internet resources. However, these resources also generate a lot of information that can be used to learn more about the people who visit these sites, and the types of products that they may or may not be interested in purchasing.

Predictive analytics may be used to identify relationships and trends from this collected information. However, this collected information may be widely dispersed within an organization. As a non-limiting example, resources may store information in differing formats, schemas, field names, and values. Consequently, processing the stored information into a useable form may require significant time and effort. As a result, there is a need for systems and method for assisting in the processing of such data into a system for analysis.

### SUMMARY

The disclosed embodiments may include systems, computer-implemented. methods, and non-transitory computer-readable media are provided for on-boarding client data received from multiple information sources. These systems, methods, and media may include a graphical user interface that receives metadata concerning information from one or more information sources. Instructions may be provided using the graphical user interface for mapping the information onto a schema of a trait-based modeling system. These instructions may be used to generate a script for onboarding the client data. The script may be provided to a server, which may execute the script, causing the resulting information to be provided to a trait-based modeling system to optimize a field in the schema of the trait-based modeling system.

The disclosed embodiments may include, for example, a computer-implemented method for onboarding information received from information sources. The method may include receiving metadata on information received from one or more information sources. The method may include receiving instructions for mapping the information onto a schema of a trait-based modeling system, generating a script based on the received instructions, and providing the script for execution. Execution of the script may generate information for provision to the trait-based modeling system. The trait-based modeling system may use the generated information to optimize a field in the schema of the trait-based modeling system.

The disclosed embodiments may include providing for concurrent display a first representation of the schema and a first representation of the metadata. The first representation of the schema may include objects representing fields of the trait-based modeling system displayed in an expandable list format, and the first representation of the metadata may include objects representing databases in the received information. The databased may be displayed in an array. In certain aspects, the disclosed. embodiments may include receiving a user selection of one of the databases in the received information, and responsive to the user selection, providing for display a second representation of the metadata. Receiving instructions may include receiving a user association between the first representation of the schema and the second representation of the metadata.

In certain aspects, the second representation of the metadata may include elements representing fields of the selected database, and the user association may include the user selection of a field of the trait based modeling system, and a field of the selected database. In some aspects, the objects representing databases in the received information may include an indication of a quality of the database. In various aspects, the elements representing the fields of the selected database may include i) at least one indication of the content of the field, and ii) an indication of a quality of the field. In some aspects, generating a script may include generating a script to optimize the selected field using the trait-based modeling system. In certain aspects, generating a script may include generating a script to perform natural language processing on the contents of the selected field using the trait-based modeling system.

The disclosed embodiments may further include providing for display a first representation of the schema including objects representing fields of the trait-based modeling system displayed in an expandable list format. The disclosed embodiments may also further include receiving a user selection of an object in the first representation representing a first field of the trait-based modeling system, and responsive to the user selection, providing for display a first representation of the metadata including at least one indication of the relevance of the metadata to the first field of the trait-based modeling system.

The disclosed embodiments may further include providing for display a representation of the metadata comprising elements representing fields of a database in the received information. In certain aspects, the disclosed embodiments may also further include receiving a user selection of a field of the database to filter. In various aspects, the disclosed embodiments may also include, responsive to the user selection, providing for display filtering options based on the contents of the selected field and receiving user instructions for filtering the selected field based on the filtering options. Generating a script may include generating a script to filter the selected field of the database.

The disclosed embodiments may further include providing for display a first representation of the metadata including elements representing fields of a first database in the received information. In certain aspects, the disclosed embodiments may also include receiving a user selection of a field of the first database as a first merger field. In various aspects, the disclosed embodiments may further include providing for display a second representation of the metadata comprising elements representing fields of a second database in the received information, responsive to the user selection of the first merger field. In some aspects, disclosed embodiments may include receiving a user selection of a second field in the second database as a second merger field corresponding to the first merger field, and responsive to the user selection of the second merger field, providing for display an indication of a connection between the first database and the second database. Generating a script may include generating a script to create a third database by merging the first database and the second database by the first merger field and the second merger field. In certain aspects, the second representation of the metadata indicates suitable merger fields, based on the selection of the first merger field.

The disclosed embodiments may further include providing for display a first representation of the metadata including elements representing fields of a first database in the received information. In certain aspects, the disclosed embodiments may include receiving a user selection of at least one first field in the first database, providing first prescriptive metric options based on the contents of the selected at least one first field, and receiving first instructions for creating the prescriptive metric responsive to the first prescriptive metric options. Generating a script may include generating a script to create the prescriptive metric based on the first instructions and to include the prescriptive metric in the resulting information provided to the trait-based modeling system.

The disclosed embodiments may further include providing for display a second representation of the metadata comprising elements representing fields of a second database in the received information. In certain aspects, the disclosed embodiments may include receiving a user selection of at least one second field in the second database, providing second prescriptive metric options based on the contents of the at least one selected second field, and receiving second instructions for creating the prescriptive metric responsive to the second prescriptive metric options. Generating a script to create the prescriptive metric based on the first instructions may include generating the script to create a prescriptive metric based on the first instructions and the second instructions.

The disclosed embodiments may further include providing for display a list of supplementary sources of information and receiving a user selection of at least one supplementary source of information. Generating a script may include generating a script to include the selected at least one supplementary source of information in the resulting information provided to the trait-based modeling system.

It is to be understood that both the foregoing general description and the following detailed description are exemplary and explanatory only and are not restrictive of the disclosed embodiments, as claimed.

### BRIEF DESCRIPTION OF THE DRAWINGS

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. In the drawings:

FIG. 1 depicts an exemplary system consistent with an embodiment of this disclosure.

FIG. 2 depicts an exemplary flow of information between components consistent with an embodiment of this disclosure.

FIG. 3 depicts an exemplary process of on-hoarding or mapping information consistent with an embodiment of this disclosure.

FIG. 4 depicts an exemplary method of providing concurrent display of the schema and the diagnostic metadata for on-boarding information consistent with disclosed embodiments.

FIG. 5 depicts an exemplary method of indicating relevant client data consistent with the disclosed embodiments.

FIG. 6 depicts an exemplary method of generating or modifying a script to combine client data consistent with the disclosed embodiments.

FIG. 7 depicts an exemplary method of generating or modifying a filtering script consistent with disclosed embodiments.

FIG. 8 depicts an exemplary method of generating or modifying a script defining a prescriptive metric consistent with disclosed embodiments.

FIG. 9 depicts an exemplary method of generating or modifying a script associating supplementary sources of information with the client data consistent with disclosed embodiments.

FIGS. 10-11 depict an exemplary user interface for on-boarding data consistent with the disclosed embodiments.

FIG. 12 depicts an exemplary user interface for recommending suitable client data consistent with disclosed embodiments.

FIG. 13 depicts an exemplary user interface for filtering client data consistent with disclosed embodiments.

FIGS. 14-16 depict an exemplary user interface for combining multiple tables consistent with consistent with disclosed embodiments.

FIGS. 17-18 depict an exemplary user interface for generating a prescriptive metric consistent with disclosed embodiments.

FIG. 19 depicts an exemplary user interface for selecting supplementary data sources consistent with disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts. It is apparent, however that the embodiments shown in the accompanying drawings are not limiting, and that modifications may be made without departing from the spirit and scope of the present disclosure.

### Exemplary System

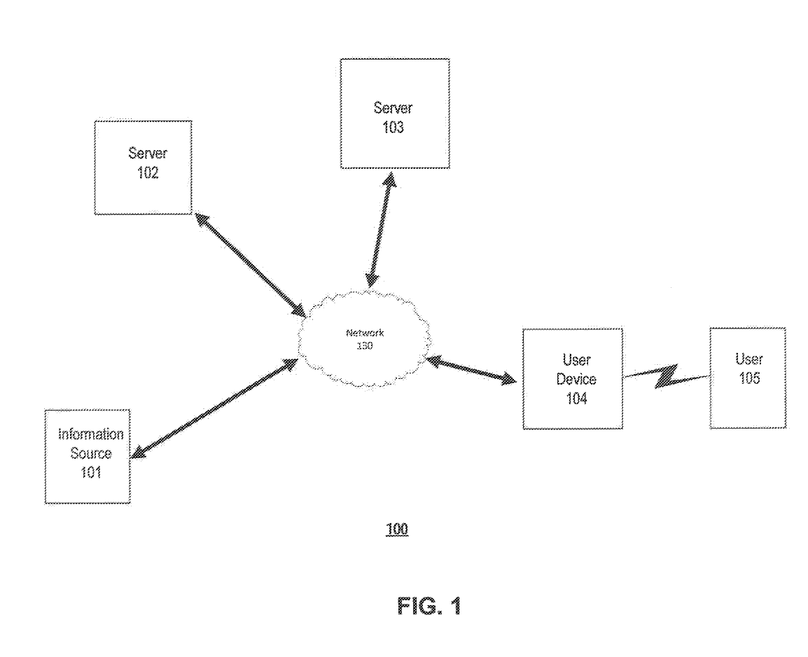

According to some embodiments, the system and methods consistent with this disclosure provide a system for onboarding client data. FIG. 1, for example, depicts an exemplary system 100 consistent with an embodiment of this disclosure. In system 100, one or more information sources 101 may provide information over network 130 to a server 102 that stores data for an entity (e.g., a client, business, agency, organization, etc.). This information may be provided over network 130 and may come in a variety of forms. For example, the information may include one or more of the following: a response to an application program interface (API) request, spreadsheets, text files, reports, website analytics, sales data, social media data, customer databases, tables, user profiles, etc. Server 102 may include one or more applications that automatically break the provided information into tables. For example, the server 102 may use artificial intelligence to classify the information into categories and/or sub-categories.

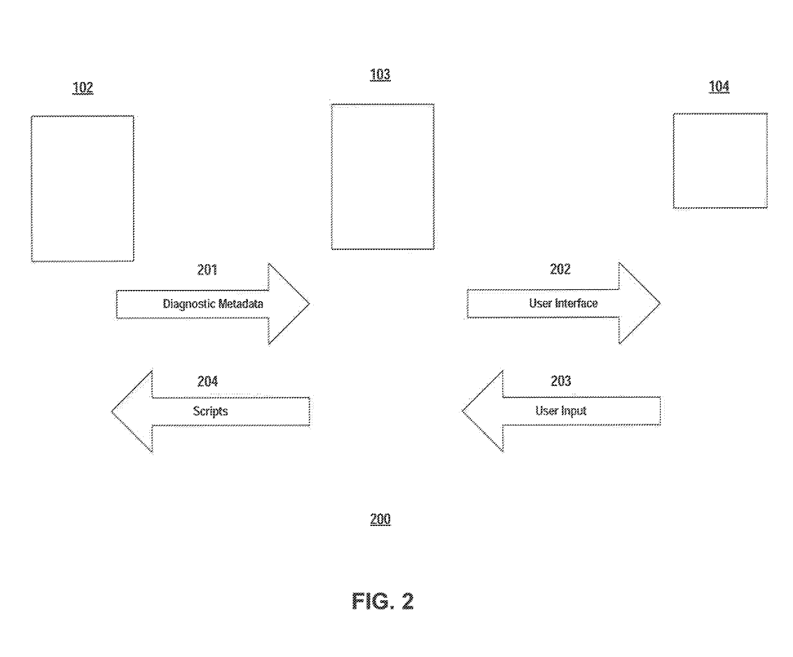

In an embodiment, server 102 may include one or more applications or scripts that generate metadata from the provided information. For example, the application or script may generate metadata about the type, structure, content, and/or attributes of the provided information. As shown in element 201 of FIG. 2, the diagnostic metadata may be provided to a server 103 for conducting the on-boarding or mapping process, which will be discussed in further detail below.

Server 103 may include one or more applications for conducting the on hoarding or mapping process. For example, server 103 may contain, or be connected to, one or more web servers that, as shown in element 202, provide instructions for generating a user interface to a user device 104. The user device 104 may include, for example, one or more of a personal computer, laptop, tablet, smartphone, mobile device. The user device 104 may include one or more of a processor, a memory, computer readable storage medium, a display, and user interfaces. The user device 104 may include a web browser that generates a user interface based on the instructions from the one or more web servers.

A display of user device 104 may present the user interface to a user 105. The user interface may be designed to interact with user 105 to conduct an on-boarding or data mapping process. The user 105 may provide user input using the user interface, and the user device 104 may present the user input, as shown in element 203, to server 103. Server 103 may use the user input to generate one or more scripts for processing the information stored (or to be stored) in server 102. As shown in element 204, these scripts may be provided by server 103 to server 102. Server 102 may then execute the scripts to complete the on-boarding or mapping process. If the one or more information sources 101 provide additional information, server 102 may use instructions from the scripts to process (e.g., filter) the additional information as it is received. These scripts may improve the stored information in one or more of the following ways: (i) the scripts may identify relationships between one or more data fields; (ii) the scripts may join data from multiple sources; (iii) the scripts may filter data; and (iv) the scripts may instruct a cleansing routine to be performed on information that remains after the scripts are processed.

In one embodiment, the information stored in server 102 may be used by a trait-based system for identifying, visualizing, predicting, and optimizing relationships between a company's objectives and a company's existing and potential customer base. To this end, the trait-based system may define a number of traits. As used herein, the term trait may refer broadly to any attribute, characteristic, value, or other factor associated with an individual or group of individuals. The detailed description below provides further examples of such traits.

For example, when receiving information about an individual, the trait-based system 100 may comprise a relationship-determining component, implemented in software, hardware, firmware, or a combination of the three. The relationship-determining component may comprise relationship-determining algorithms that may determine correlations, between the information collected about an individual and traits that the individual may or may not have. These correlations may be described using a numerical value, textual identifier, graphical icon, color, opacity, or other suitable method of representing the relationship. The correlations may represent how strongly the information is related to the traits, including the lack of any relationship at all. The relationship may also be identified as positive, negative, or neutral. The term “positive” may broadly refer to a relationship where the existence of, or a change in, one member of the relationship corresponds to a similar existence of or a similar change in, the other members. The term “negative” may broadly refer to a relationship where the existence of, or a change in one member of the relationship corresponds to a lack of the existence of, or an inverse change in, the other members. The term “neutral” may broadly refer to a relationship where the existence of, or a change in one member of the relationship does not correspond to any existence or change in the other members.

In some embodiments, the system 100 may also be configured to receive a metric, representing an overall goal or interest of a company. As used herein, the term metric broadly refers to any attribute, measurement, goal, strategy, or other information of interest. The metric may also consist of a number of sub-metrics. As used herein, the term sub-metric broadly refers to any attribute, measurement, goal, strategy, or other information related to the metric. For example, the system may use a relationship-determining component to identify relationships between one or more metrics and the traits of an individual. The system may also determine the relationship between groups of traits and the metric, and individuals and the metric. In this manner, the organization may gain information on how personality types or individuals contribute to a metric of interest.

The system 100 may also contain a visualization component that may be used to display the correlations between traits that an individual, or group of people, may or may not possess, and the information collected about that person or group of people.

All components of FIG. 1 may be disposed for communication with one another via electronic network 130, which may comprise any form or combination of networks for supporting digital communication, including the Internet. Examples of such an electronic network include a local area network (LAN), a wireless LAN (e.g., a “WiFi” network), a wireless Metropolitan Area Network (MAN) that connects multiple wireless LANs, a wide area network (WAN) (e.g. the Internet), and/or a dial-up connection (e.g., using a V.90 protocol or a V.92 protocol). In the embodiments described herein, the Internet may include any publicly-accessible network or networks interconnected via one or more communication protocols, including, but not limited to, hypertext transfer protocol (HTTP) and transmission control protocol/internet protocol (TCP/IP). Moreover, the electronic network may also include one or more mobile device networks, such as a 4G network, LTE network, GSM network or a PCS network, that allow a computing device or server system, to send and receive data via applicable communications protocols, including those described above.

The various components of the system of FIG. 1 may include an assembly of hardware, software, and/or firmware, including memory, a central processing unit (“CPU”), and/or a user interface configured to perform their disclosed function. For example, they may include any type of RAM or ROM embodied in a physical storage medium, such as magnetic storage including floppy disk, hard disk, or magnetic tape; semiconductor storage such as solid state disk (“SSD”) or flash memory; optical disc storage; or magneto-optical disc storage. A CPU may include one or more processors for processing data according to a set of programmable instructions or software stored in memory. The functions of each processor may be provided by a single dedicated processor or by a plurality of processors. Moreover, the components may include any type or combination of input/output devices, such as a display monitor, keyboard, touch screen, and/or mouse.

### Exemplary On-Boarding or Mapping Process

In one embodiment, a method for on-boarding or mapping information into a schema of another system (e.g., the trait-based system discussed above) is disclosed. The method or portions of the method, discussed below, may be repeated for each information source 101. While discussed as a particular sequence of steps, a person of ordinary skill in the art would understand that the process could be performed by combining, removing, or reordering the steps.

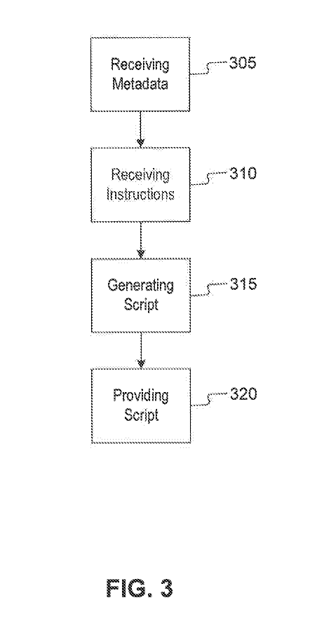

FIG. 3 shows an exemplary method of generating or modifying a script to on-board client data consistent with disclosed embodiments. As discussed above, in the step of receiving metadata 305, server 103 may receive from server 102 diagnostic metadata 201. This diagnostic metadata may be generated by server 102 from information received by server 102 from information sources 101. Server 103 may use diagnostic metadata 201 to generate a user interface 202 for on-boarding or mapping the information onto the schema of another system. In some embodiments, this system may be a trait-based modeling system.

The exemplary method may comprise a further step of receiving instructions 310 from the user device 104. These instructions may be received in response to the generated user interface provided by server 103. In some embodiments, these instructions may specify associations between fields of the trait-based modeling system and the received information. In other embodiments, these instructions may specify tables containing fields similar to an indicated a field of the trait-based modeling system. In another embodiment, these instructions may specify filtering of received information. These instructions may specify generation of a third table based on a first table and a second table in the received information in another embodiment. These instructions may specify generation of a prescriptive metric in another embodiment. In some embodiments, these instructions may specify provision of supplementary sources of information to the trait-based modeling system.

The method may comprise a step of presenting, on user device 104, the user 105 with an option of implementing the instructions consistent with the disclosed embodiments. Server 103 may use these instructions to generate a script (step 315). As discussed above, that script may then be sent to server 102 and executed on the information (step 320). For example, the script may join information based on the mapping identified using the user interface. Running the script may also include running one or more cleansing processes on the resulting set of information. The resulting information may be provided by server 102 to the trait-based system for modeling. In some embodiments, this step may be completed without modifying the underlying information. These steps and further variations on these steps are described in greater detail below.

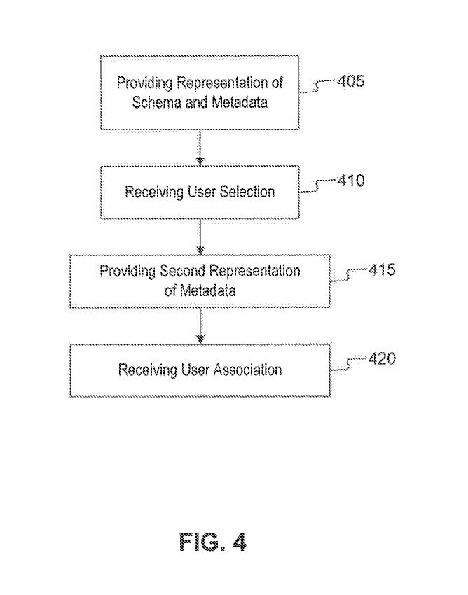

FIG. 4 shows an exemplary method of on-boarding or mapping client data consistent with the disclosed embodiments. In some embodiments, this method comprises providing for concurrent display on the user device 104 multiple representations of data (step 405). In such embodiments, the multiple representations may include a first representation of the schema of the trait-based modeling system. This first representation may comprise objects representing fields of the trait-based modeling system. These objects may be displayed in an expandable list format for convenient navigation by the user 105. For example, objects corresponding to a first hierarchical level of the trait-based modeling system may be displayed, each object associated with a display control. In such an example, user selection of the display control associated with the object may cause the user interface to display a second hierarchical level of the trait-based modeling system. In a further example, user selection of a display control associated with an object in the second hierarchical level may cause the user interface to display a third hierarchical level of the trait-based modeling system, and so forth. In alternative embodiments, the user may select an object of the current hierarchical level corresponding to an element of the trait-based modeling system in order to map client data to that element. In some embodiments, the multiple representations may include a first representation of the diagnostic metadata 201 received from the server 102. In such embodiments, this first representation of the metadata may comprise objects representing tables in the received information. This first representation of the metadata may be displayed concurrently with the first representation of the schema of the trait-based modeling system. In further such embodiments, these objects may be grouped by information source and displayed in an array. In additional embodiments, the objects representing tables in the received information may comprise indications of a quality of the table. For example, fields may be low quality if they are empty, incomplete, and/or contain data errors (e.g., a state field that contains zip codes).

This method may comprise the step 410 of receiving a user selection 203 consistent with disclosed embodiments. In some embodiments, user selection 203 may indicate an object in the first representation of the metadata. The selected object may correspond to a table in the received information.

This method may comprise the step 415 of providing for display on the user device 104 a second representation of metadata consistent with the disclosed embodiments. In some embodiments, this second representation may be provided for concurrent display with the first representation of the schema of the trait based modeling system. In such embodiments, this second representation may show fields in the selected table. In some embodiments, the second representation of the table is a matrix with a row for each field in the table. In these embodiments, the elements of the matrix may comprise at least one indication of the content of the field and an indication of the quality of the field. In some embodiments, such content indications may include matrix elements displaying additional metadata associated with the selected table. This additional metadata may include identifiers, datatypes, number of datapoints, and number of distinct datapoints for each field. Quality of a field may be indicated at least by one or more of the color, font, size, placement, or shape of at least one or more matrix elements. The second representation may include a mapping column for associating a field of the selected table and a field of the trait-based modeling system.

This method may comprise the step 420 of receiving a user association between a field of the selected table and a field of the trait-based modeling system. In some embodiments, this association may comprise indicating the trait of the trait-based modeling system and indicating the field of the selected table. In such embodiments, this indication may be effectuated through any number of user actions familiar to one of ordinary skill in the art. For example, as described above, user 105 may interact with user device 104 to indicate a field of the trait-based modeling system by pressing a keyboard key, clicking a mouse button, or gesturing on a touch-sensitive interface. User 105 may similarly interact with the user device 104 to indicate a field of the selected table. In some embodiments, a single user action may indicate both the field in the trait-based modeling system and the field of the selected table. For example, user 105 may tap and drag a representation of the indicated field of the trait-based modeling system from a first location to a second location of a touch-sensitive interface of user device 105. In such embodiments, the first location may correspond to the field of the trait-based modeling system. The second location may correspond to an element of the matrix. In such embodiments, the column of this element may be the mapping column and the row may correspond to the selected field of the table.

This method may comprise the step of providing, for display on user device 104, an indication of the association between the field of the trait-based modeling system and the field of the table consistent with disclosed embodiments. This indication may be provided in the matrix for the table. In some embodiments, this indication may be provided in the element of the mapping column corresponding to the indicated field of the selected table. For example, this element of the mapping column may be populated by the representation of the trait-based modeling system dragged from the expandable list.

As described above, this method may comprise a script generation step consistent with disclosed embodiments. In some embodiments, the server 103 may generate a script based on the instructions received from the user device 104. In some embodiments, this script may specify the optimization of the selected field of the table using the trait-based modeling system. In other embodiments, this script may specify performing natural language processing on the content of the selected field using the trait-based modeling system. The schema for the trait-based modeling system may differentiate between content provided to a third party and content received from a third party. For example, the natural language processing may be performed on solicitations provided to third parties to identify effective language. As an additional example, natural language processing may be performed on complaints received from customers to identify weaknesses in customer service.

As described above with reference to FIG. 3, process 400 may comprise a provision step in which the server 103 provides the script to the server 102. Server 102 may execute the script, generating resulting information for provision to the trait-based modeling system.

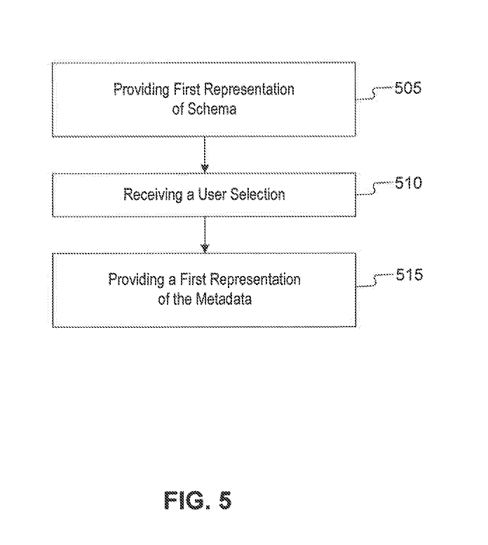

FIG. 5 shows an exemplary method of indicating relevant client data consistent with the disclosed embodiments. This method may comprise a step 505 of providing a first representation of the schema of the trait-based modeling system. User 105 may interact with the user device 104 using a control displayed on the user interface to instruct the server 103 to display on the user device 104 suitable data (step 510). User 105 may also interact with the user device 104 to select a field in the schema of the trait-based modeling system. Responsive to the user selection 203, server 103 may provide a first representation of the diagnostic metadata 201 (step 515). This representation may include an indication of the relevance of the metadata. Such an indication may distinguish more relevant metadata from less relevant metadata in terms of color, font, size, or position. For example, server 103 may receive user selections 203 of the field “username” in the schema for the trait-based modeling system and the control labeled “Help me tag it.” In this example, server 103 may provide for display by the user device 104 a first representation of the descriptive metadata 201 indicating the presence of “username” data in information received from multiple information sources. In some embodiments, the first representation may comprise objects corresponding to the tables in the received information. In such embodiments, the objects corresponding to tables containing “usemame” information may be colored differently from the other objects of the first representation. As a further example, the hue of the objects corresponding to relevant metadata may be the same as hue of the objects representing the selected field of the schema, while another color property, such as brightness or saturation, may vary according to a second characteristic of the relevant data, such as the quality of the relevant fields. In other embodiments, an icon may be displayed to indicate the relevance of the objects, such as a check mark or a plus sign.

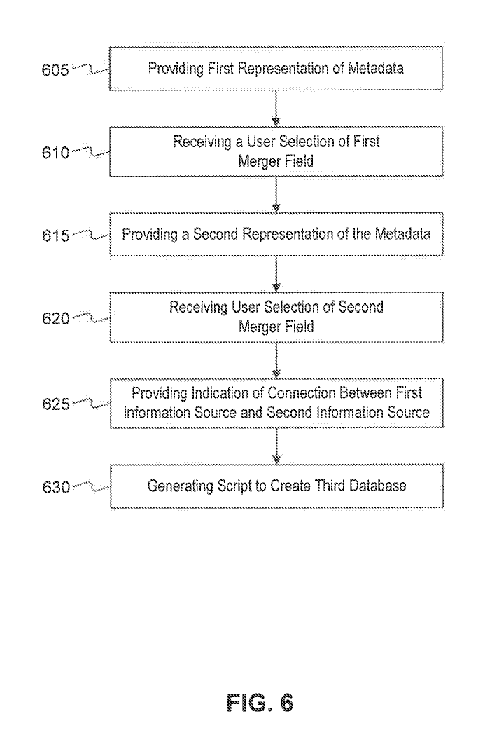

FIG. 6 shows an exemplary method of generating or modifying a script to combine client data consistent with the disclosed embodiments. In some embodiments, the script generated may specify that the third table include the fields from the first database and the field from the second database combined according the values of the first merger field and the second merger fields. This method may include the step 605 of providing a first representation of the diagnostic metadata 201 for display on the user device 104 consistent with the disclosed embodiments. In some embodiments, this representation of the diagnostic metadata 201 may represent fields of a first table in the received information.

This method may further include the step 610 of receiving a user selection 203 of a first merger field. In some embodiments, this user selection may be effectuated through any number of user actions familiar to one of ordinary skill in the art. For example, user 105 may interact with user device 104 to indicate the first merger field by pressing a keyboard key, clicking a mouse button, or gesturing on a touch-sensitive interface.

This method may further include the step 615 of providing a second representation of the diagnostic metadata 201 for display on the user device 104. In some embodiments, this representation of diagnostic metadata 201 may represent fields of a second table. In some embodiments, the second representation of the table is a matrix with a row for each field in the table. In these embodiments, the elements of the matrix may comprise at least one indication of the content of the field and an indication of the relevance of the field. In some embodiments, such content indications may include matrix elements displaying additional metadata associated with the selected table. This additional metadata may include identifiers, datatypes, number of datapoints, and number of distinct datapoints for each field. Relevance of a field may be indicated at least by one or more of the color, font, size, placement, or shape of at least one or more matrix elements. For example, rows of the matrix corresponding to relevant fields may be placed at the top of the matrix. In some embodiments, such rows may be further called out with icons, such as plus signs. The determination of relevance may be made according to artificial intelligence methods. The second representation may include a mapping column for associating the first merger field and a second merger field. User 105 may interact with the user device 104 to indicate a second merger field in the second table by any number of user actions familiar to one of ordinary skill in the art (step 620). For example, user 105 may interact with user device 104 to indicate the first merger field by pressing a keyboard key, clicking a mouse button, or gesturing on a touch-sensitive interface. In sonic embodiments, the fields of the first table and the fields of the second table may be concurrently displayed. In such embodiments, a single user action may indicate both the first merger field of the first table and the second merger field of the second table. For example, user 105 may tap and drag a representation of the indicated field of the trait-based modeling system from a first location to a second location of a touch-sensitive interface of user device 105. In such embodiments, the first location may correspond to the first merger field of the first table. The second location may correspond to an element of the matrix. In such embodiments, the column of this element may be the mapping column and the row may correspond to the selected second merger field of the second table.

This method may further comprise the step 625 of providing, for display on user device 104, an indication of the relationship of the first table and the second table consistent with disclosed embodiments. In such embodiments, this indication may show that the script may specify the combination of the first table and the second table according to the values of the first merger field of the first table and second merger field of the second table. In some embodiments, this indication may be provided in the matrix for the second table. For example, the row of the mapping column corresponding to the merger field may include an indication of the combination, such as a field identifier for the first merger field. In other embodiments, the server 103 may provide user device 104 a third representation of diagnostic metadata 201, indicating that the script will specify the combination of the first table and the second table. In such embodiments, the indication distinguishing the second table from tables not combined with the first table may include at least one of color, placement, or font, or the addition of an icon to the representation of the second table. For example, the third representation of the second table may include a check mark or plus sign to indicate that it will be combined with the first table.

As described above, the method may further comprise the step 630 of generating or modifying a script to create a third table. This script may specify the creation of the third table from the second table and the first table by merging according to the values of the first and second merger fields. The script may specify that the third table include every field in either the first or second table. For each unique value of the first and second merger fields, a record may be created in the third table.

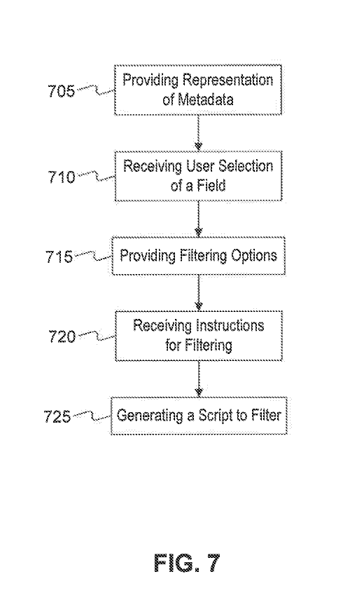

FIG. 7 shows an exemplary method of generating or modifying a filtering script consistent with disclosed embodiments. The disclosed embodiments may enable the user 105 to specify the scope of the data that will be used to conduct analytics. For example, the user 105 may specify a time period, product type, geographic region, etc. This method may include the step 705 of providing a first representation of the diagnostic metadata 201 for display on the user device 104. In some embodiments, this representation may comprise elements of a matrix, each row of the matrix corresponding to a field in the table. In such embodiments, a filter column may be provided comprising a user selectable control for generating or modifying a script by specifying the filtering of the contents of the field. Responsive to user selection 203 of this control (step 710), the server 103 may provide for display on the user device 104 a list of options of filtering options based on the contents of the selected field (step 715). For example, if the selected field contains numerical data then the user interface may provide options for selecting a minimum and a maximum value. As an additional example, if the selected field contains enumerated data, such as responses to multiple choice questions, then the user interface may provide a user-selectable list based on values of the field contents. As a further example, if the selected field contains dates, the user interface may provide a beginning and end date. The method may include the further step 720 of receiving the user instructions, comprising, for example, the provided minimum and maximum values, selected enumerated items, and beginning and end dates. The method may also include the further step 725 of generating or modifying a script to filter the selected field of the database based on the information provided by the user. Therefore, in each of these examples, the information provided by the user may determine the contents of the field provided to the trait-based modeling system.

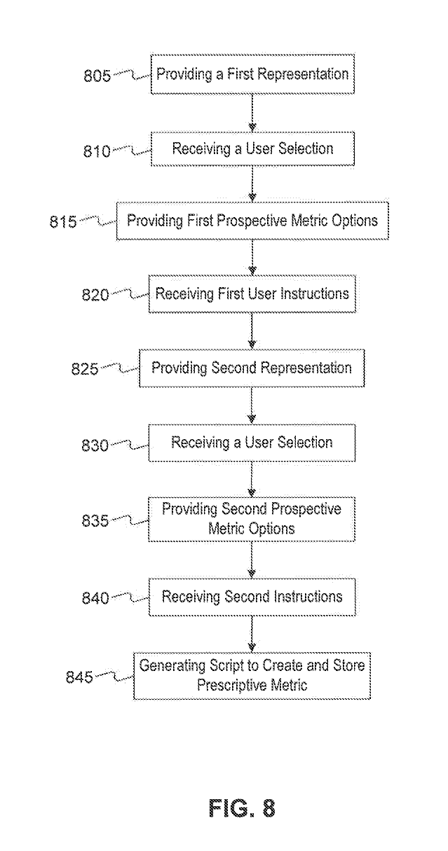

FIG. 8 shows an exemplary method of generating or modifying a script defining a prescriptive metric consistent with disclosed embodiments. This method may include the step 805 of the server 103 providing for display by the user device 104 a first representation of the diagnostic metadata 201. In some embodiments, this first representation includes first elements representing fields of a first table in the received information. The user display may allow the user 105 to select one or more of these first elements as a metric for the trait-based system discussed above. This selection may then be received by server 103 (step 810). Based on the user selection 203, the server 103 may provide a first set of prescriptive metrics options (step 815). In some embodiments, the options may include controls permitting the user to provide equations as a metric for the trait-based system. These equations may take as variables the fields corresponding to the selected first elements of the first representation. For example, the user 105 may specify as a prescriptive metric a ratio between two fields corresponding to the selected first elements. The user 105 may also specify the level of aggregation of the data used to calculate the metric. For example, the user 105 may choose between calculating the proscriptive metric at the level of an individual, or at an overall or total level. In step 820, the server 103 may receive these user instructions 203. In further embodiments, a second representation of the metadata comprising elements representing fields of a second table in the received information is provided by server 103 for display on user device 104 (step 825). In some embodiments, the second table may correspond to information received by server 102 from a second source of information 101. This second source of information may be different than the source of information corresponding to the first table. The user display may allow the user 105 to select one or more of these second elements as a metric for the trait-based system discussed above. This selection may then be received by server 103 (step 830). Based on the user selection 203, the server 103 may provide a second set of prescriptive metrics options (step 835). As discussed above, in some embodiments the options may include controls permitting the user to provide equations as a metric for the trait-based system. In step 840, the server 103 may receive these user instructions 203. The server may then. generate or modify a script 204 based on the first instructions and the second instructions (step 845). In some embodiments, only one table is selected and the script is generated or based only on one set of instructions. In some embodiments, the trait-based modelling system may then be used to optimize (e.g., increase or decrease) the identified field or relationship. When an equation is used, the server 103 may include in the script instructions to generate a new data field that stores the result of the equations. This may prevent the system from having to recalculate the data by calculating incremental changes based on newly received information. In some embodiments, the prescriptive metric may be calculated based on the fields from multiple sources of information. For example, the prescriptive metric may be based on a transaction cost from a table stored in one database and offset from a table stored in another database. In such situations, the server 103 may cause the user interface of the user device 104 to display second prescriptive metric options based on the contents of the at least one selected second field (step 825). Server 103 may generate or modify a script based the first and second instructions corresponding to the first and second prescriptive metric options (step 845).

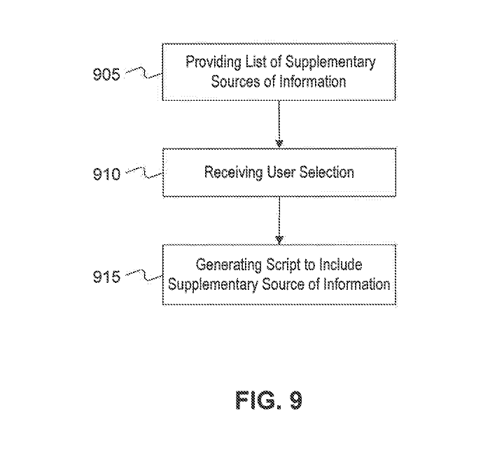

FIG. 9 shows an exemplary method of generating or modifying a script associating supplementary sources of information with the client data consistent with disclosed embodiments. In some embodiments, method includes server 103 providing, for display to user device 104, a list of proprietary supplementary sources of information, such a census data, weather data, property data, and personality and trait scoring data (step 905). The display may allow the user 105 to select one or more of these tables for provision to the trait-based modeling system. Server 103 may then receive the user's selection (step 910). Responsive to the user selection, the server 103 may generate a script to include these supplemental sources of information (step 915).

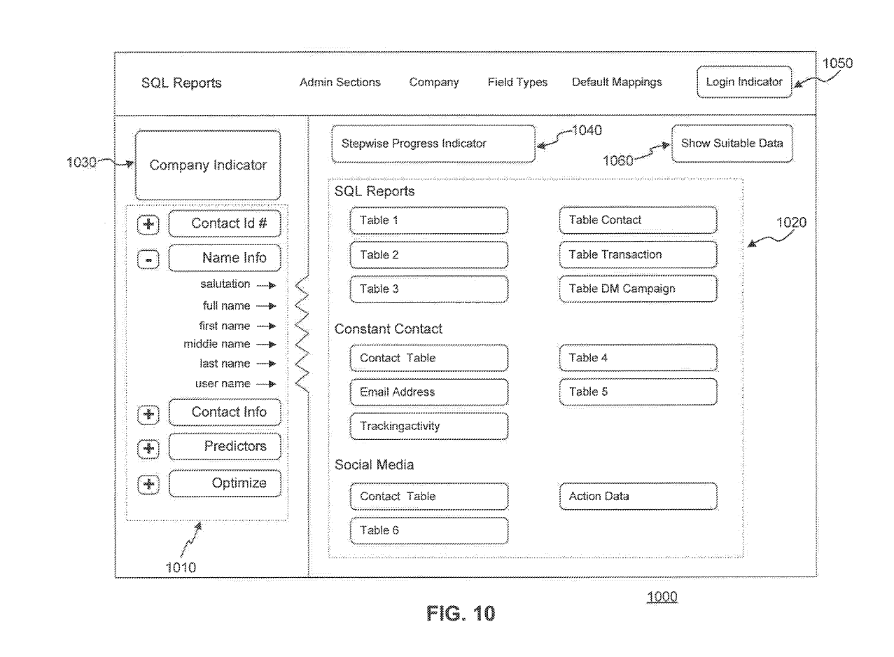

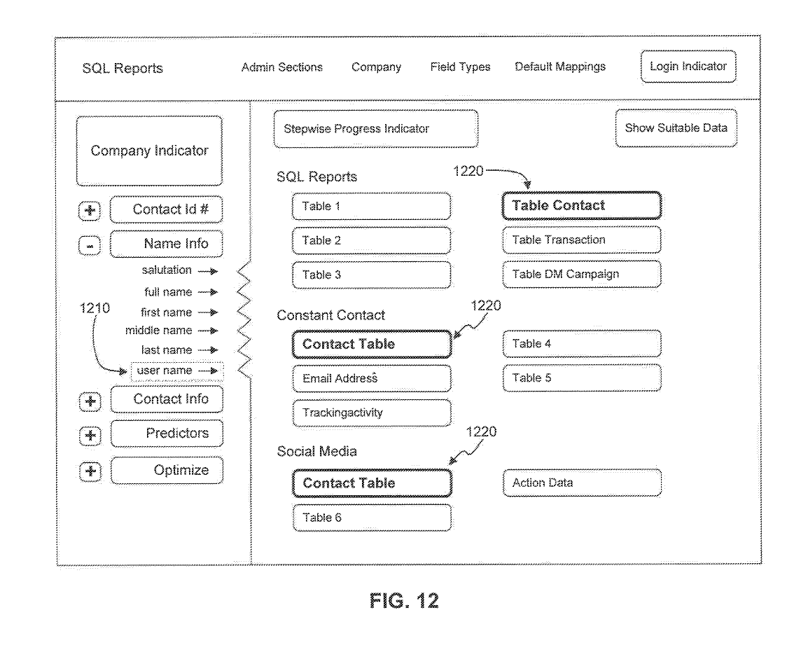

FIG. 10 depicts an exemplary user interface 1000 for on-boarding data consistent with the disclosed embodiments. In some embodiments user interface 1000 may concurrently display a first representation of a schema of the trait-based modeling system in an expandable list format 1010, a first representation of the diagnostic metadata 1020, a company indicator 1030, a stepwise progress indicator 1040, a login indicator 1050, and a show suitable data control 1060. The first representation in an expandable list format 1010 may show a first hierarchical level of the schema, together with user selectable display controls, that when selected cause the user interface to display a second hierarchical level of the schema. The first representation of the diagnostic metadata 1020 may display sources of the diagnostic metadata and objects arranged in an array indicating tables within each source. The company indicator 1030 may display the company for which the onboarding process is performed, while the login indicator 1050 may display the individual that is performing the onboarding process. The stepwise progress indication 1040 may show the several steps comprising the onboarding process and the current step in the process being performed. The stepwise progress indicator 1040 may be user-selectable to navigate the several steps of the onboarding process. The show suitable data control 1060, discussed with reference to FIG. 12 below, may be user-selectable to cause the user interface to recommend data for association with fields of the trait based modeling system.

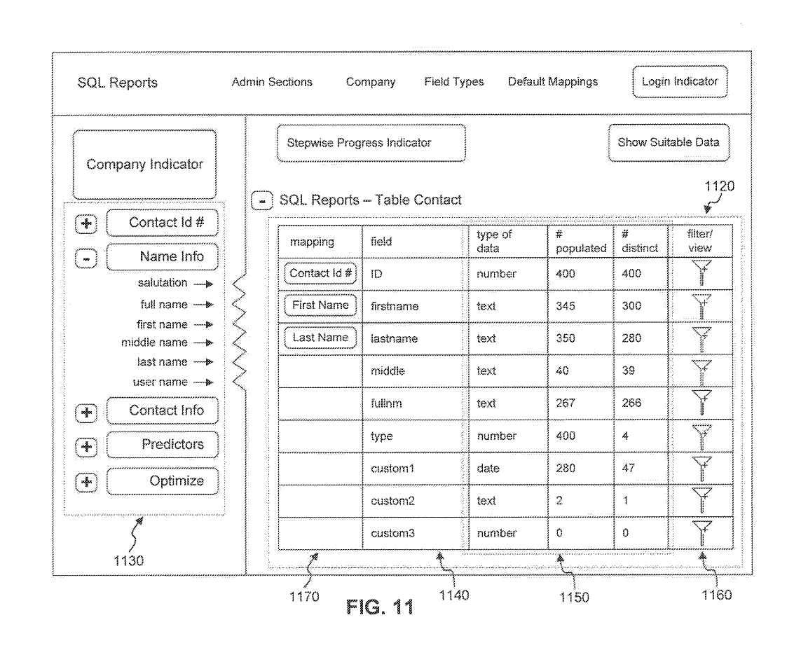

FIG. 11 depicts a second representation of the diagnostic metadata 1110. This second representation may include a matrix depicting a table of the diagnostic metadata 1120. The rows of the matrix may be associated with the fields of the table. The matrix may have a column indicating a mapping between the fields of the matrix and the fields of the schema 1130, a column indicating a field identifier of the table 1140, columns indicating descriptive statistics of the fields of the table 1150, and a column containing a filtering control for each field of the table 1160. The column of the matrix indicating a mapping 1170 may be populated with representations of fields in the schema of the trait-based modeling system indicating the existence of an association between the field of the schema and the field of the table.

FIG. 12 depicts an exemplary user interface for recommending suitable client data consistent with disclosed embodiments. Upon selection of the show suitable data control 1060 and a field in in the schema of the trait-based modeling system 1210, the user interface may highlight objects 1220 in the representation of the diagnostic metadata 1020 to indicate the presence of data in the tables corresponding to the objects relevant to the selected field of the trait-based modeling system.

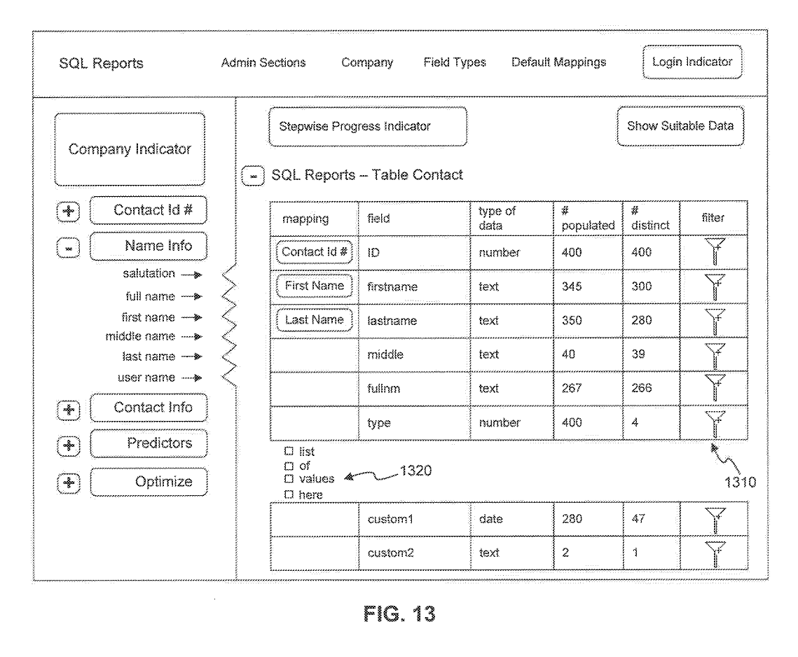

FIG. 13 depicts an exemplary user interface for filtering client data consistent with disclosed embodiments. As described above, the columns of the matrix depicting a table of the diagnostic metadata 1120 include a column having user-selectable filtering controls 1160. Selection of a filtering control for a field of the table 1310 causes the user interface to provide filtering options 1320 for the content in that field. In some embodiments, the methods and systems for onboarding data may generate a script to filter the content in the field corresponding to the selected control 1310 based on the user input 203 provided in responses to the filtering options 1320.

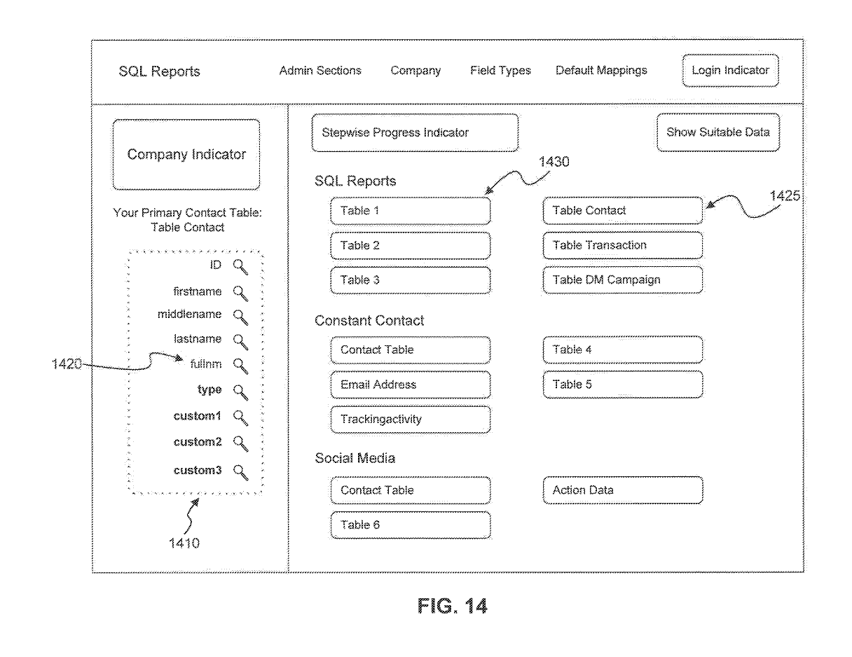

FIG. 14 depicts the first step in interacting with an exemplary user interface for combining multiple tables consistent with consistent with disclosed embodiments. In some embodiments, the user interface provides a first representation of metadata 1410 comprising elements (e.g. element 1420) representing fields of a first table 1425 in the diagnostic metadata. User 105 may interact with user device 104 to select element 1420 corresponding to a field of the table. The user may also select a table 1430 from the first representation of the diagnostic metadata 1020.

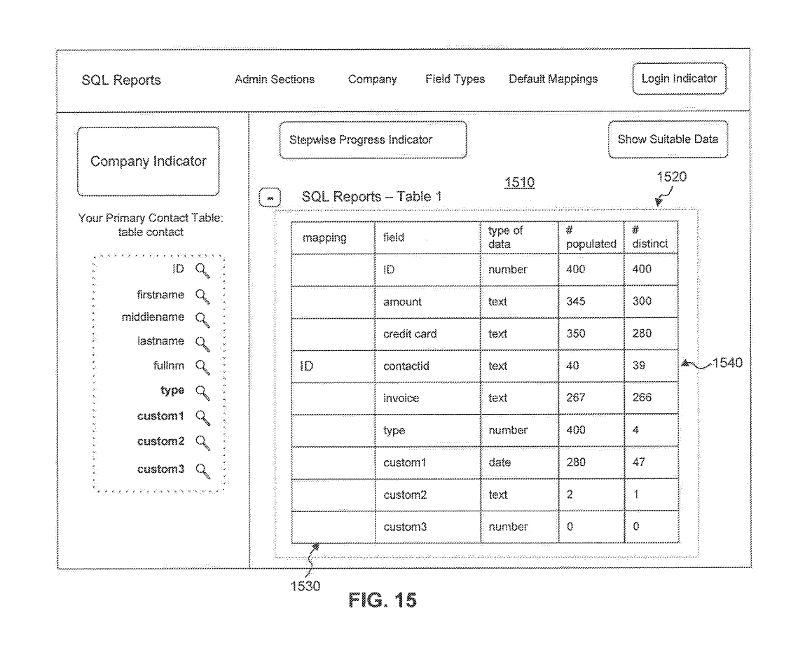

FIG. 15 depicts the second step in interacting with exemplary user interface for combining multiple tables consistent with consistent with disclosed embodiments. Responsive to the selection of element corresponding to a field 1420 and table 1430, the user interface may provide a second representation of the diagnostic metadata 1510. This second representation may include a matrix 1520 haying a column 1530 indicating a mapping between the field corresponding to element 1420 and a field corresponding to a row of the matrix 1540. In some embodiments, the order of presentation of the rows corresponding to the fields of the matrix may depend on the similarity of the contents of those fields to the field corresponding to selected element 1430.

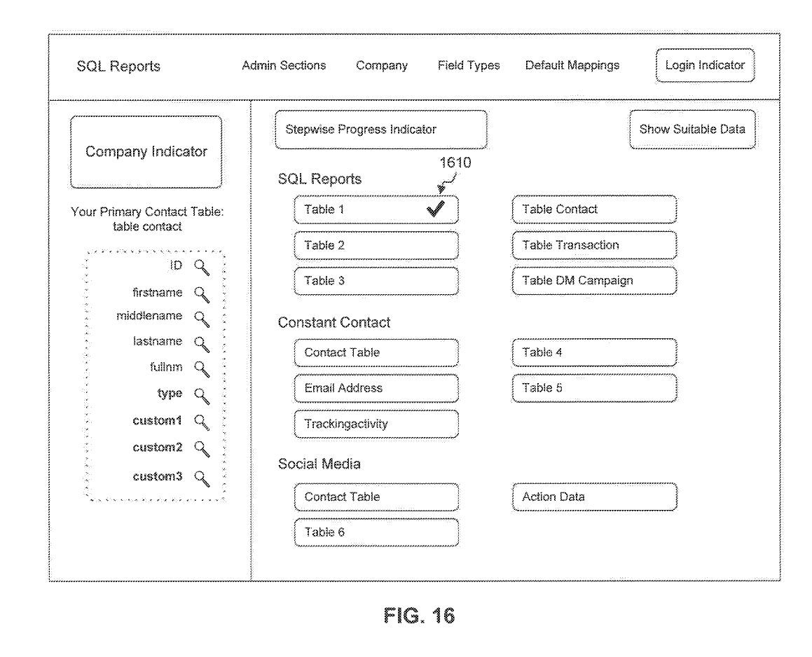

FIG. 16 depicts an exemplary user interface for combining multiple tables consistent with consistent with disclosed embodiments, following the association of the field corresponding to selected element 1430 with the field corresponding to matrix row 1540. In some embodiments, the user interface may provide table 1440 an indication 1610 of the connection between the table 1440 and the table 1425.

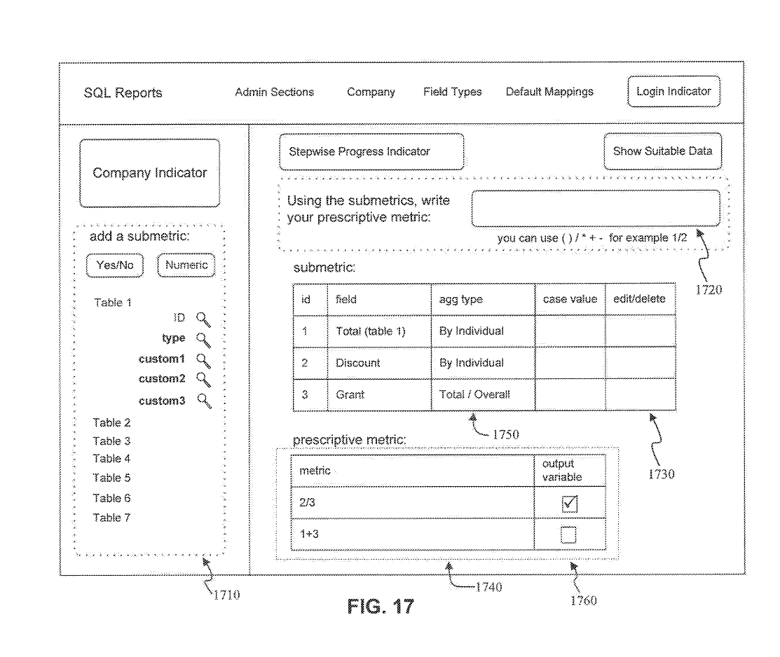

FIG. 17 depicts an exemplary user interface for generating a prescriptive metric 1700 consistent with disclosed embodiments. In some embodiments, the user interface provides a field selector 1710, a formula box 1720, a submetric listing 1730, and a prescriptive metric listing 1740. Field selector 1710 provides a representation of the diagnostic metadata 201 in an expandable list format. The user 105 may interact with user device 105, using field selector 1710 to select a field in the diagnostic metadata 201 as a source for a submetric and indicate whether the submetric would be a numeric submetric. Additionally, in some embodiments the user 105 may use formula box 1720 to provide a formula relating at least one submetric to a prescriptive metric. In some embodiments, submetric listing 1730 provides a list of the submetrics chosen as potential bases for prescriptive metrics and descriptive statistics of those chosen submetrics, including a column 1750 indicating an aggregation level for each submetric. In some embodiments, selecting elements of submetric listing 1730 may allow the user to access and modify information relating to the chosen submetrics. In some embodiments, prescriptive metric listing 1740 depicts the available prescriptive metrics, including a column containing a user-selectable control setting the prescriptive metric as a variable for optimization 1760. In some embodiments, selecting elements of prescriptive metric listing 1740 may allow the user to access and modify information relating to the defined prescriptive metrics.

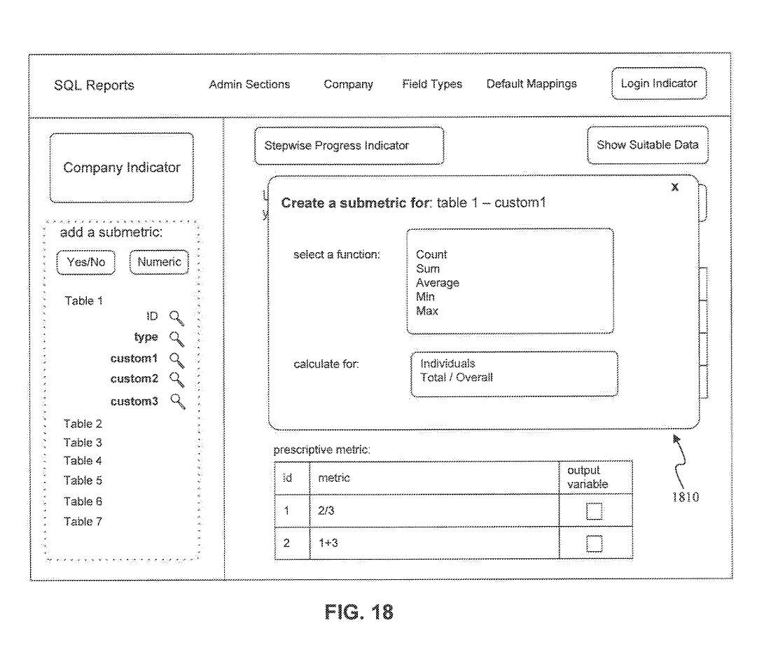

FIG. 18 depicts a dialog 1810 for defining submetrics. In some embodiments, the user interface may provide this dialog responsive to the selection of a field using field selector 1710. In other embodiments, the user interface may provide dialog 1810 responsive to selection of another element of user interface 1700, such as submetric listing 1730. Dialog 1810 provides options for generating or modifying the submetric created from the selected field, including a choice of functions to perform on the data and a choice of aggregation levels for the calculation.

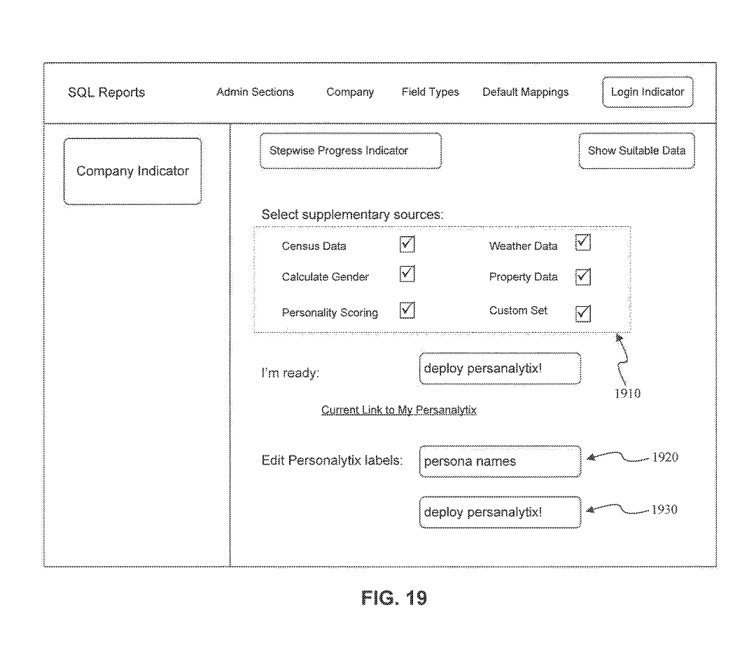

FIG. 19 depicts an exemplary user interface for selecting supplementary data sources consistent with disclosed embodiments. In some embodiments, user-selectable controls 1910 are provided for selecting supplementary data sources to include in the information provided to the trait-based modeling system. In certain embodiments, control 1920 allows for the company or user-specific modification of labels associated with the fields in the schema of the trait-based modeling system. In other embodiments, a deployment control 1930 is provided. In such embodiments, selection of the deployment control will cause server 103 to generate a script based on the user input 203 and provide the scrip 204 to the server 102, causing server 102 to provide data to the trait-based modeling system.

The methods disclosed herein may be implemented as a computer program product comprising computer-readable instructions. Computer-readable instructions may be stored on a tangible non-transitory computer-readable medium, such as a flexible disk, a hard disk, a CD-ROM (compact disk-read only memory), an MO (magneto-optical) disk, a DVD-ROM (digital versatile disk-read only memory), a DVD RAM (digital versatile disk-random access memory), or a semiconductor memory. Alternatively, the methods may be implemented in hardware components or combinations of hardware and software of a data processing apparatus, e.g., a. programmable processor, a computer, or multiple computers. The computer program may be written in any form of programming language, including compiled or interpreted languages, and it may be deployed in any form, including as a standalone program or as a module, component, subroutine, or other unit suitable for use in a computing environment. A computer program may be deployed to be executed on one computer or on multiple computers at one site or distributed across multiple sites and interconnected by a communication network.

In the preceding specification, the embodiments have been described with reference to specific exemplary embodiments. It will however, be evident that various modifications and changes may be made without departing from the broader spirit and scope of the exemplary embodiments as set forth in the claims that follow. The specification and drawings are accordingly to be regarded as illustrative rather than restrictive sense. Other embodiments of the present disclosure may be apparent to those skilled in the art from consideration of the specification and practice of the description disclosed herein.

What is claimed is:

1. A computer implemented method comprising:
receiving metadata on information received from one or more information sources;
receiving instructions for mapping the information onto a schema of a trait-based modeling system;
generating a script based on the received instructions; and
providing the script, wherein the resulting information is provided to the trait-based modeling system to optimize a field in the schema of the trait-based modeling system.

2. The method of claim 1, further comprising
providing for concurrent display a first representation of the schema comprising objects representing fields of the trait-based modeling system displayed in an expandable list format, and a first representation of the metadata comprising objects representing databases in the received information displayed in an array;
receiving a user selection of one of the databases in the received information;
responsive to the user selection, providing for display a second representation of the metadata; and
wherein receiving instructions comprises receiving a user association between. the first representation of the schema and the second representation of the metadata.

3. The method of claim 2, wherein.
the second representation of the metadata comprises elements representing fields of the selected database, and
the user association comprises the user selection of
a field of the trait based modeling system, and
a field of the selected database.

4. The method of claim 2, wherein the objects representing databases in the received information comprise an indication of a quality of the database.

5. The method of claim 3, wherein the elements representing the fields of the selected database comprise i) at least one indication of the content of the field, and ii) an indication of a quality of the field.

6. The method of claim 3, wherein generating a script comprises generating a script to optimize the selected field using the trait-based modeling system.

7. The method of claim 3, wherein generating a script comprises generating a script to perform natural language processing on the contents of the selected field using the trait-based modeling system.

8. The method of claim 1, further comprising
providing for display a first representation of the schema comprising objects representing fields of the trait-based modeling system displayed in an expandable list format;
receiving a user selection of an object in the first representation representing a first field of the trait-based modeling system; and
responsive to the user selection, providing for display a first representation of the metadata including at least one indication of the relevance of the metadata to the first field of the trait-based modeling system.

9. The method of claim 1, further comprising
providing for display a representation of the metadata comprising elements representing fields of a database in the received information;
receiving a user selection of a field of the database to filter;
responsive to the user selection, providing for display filtering options based on the contents of the selected field;
receiving user instructions for filtering the selected field based on the filtering options; and
wherein generating a script comprises generating a script to filter the selected field of the database.

10. The method of claim 1, further comprising
providing for display a first representation of the metadata comprising elements representing fields of a first database in the received information;
receiving a user selection of a field of the first database as a first merger field;
responsive to the user selection of the first merger field, providing for display a second representation of the metadata comprising elements representing fields of a second database in the received information;
receiving a user selection of a second field in the second database as a second merger field corresponding to the first merger field,
responsive to the user selection of the second merger field, providing for display an indication of a connection between the first database and the second database; and
wherein generating a script comprises generating a script to create a third database by merging the first database and the second database by the first merger field and the second merger field.

11. The method of claim 1, wherein the second representation of the metadata indicates suitable merger fields, based on the selection of the first merger field.

12. The method of claim 1, further comprising
providing for display a first representation of the metadata comprising elements representing fields of a first database in the received information;
receiving a user selection of at least one first field in the first database;
providing first prescriptive metric options based on the contents of the selected at least one first field;
receiving first instructions for creating the prescriptive metric responsive to the first prescriptive metric options;
wherein generating a script comprises generating a script to create the prescriptive metric based on the first instructions and to include the prescriptive metric in the resulting information provided to the trait-based modeling system.

13. The method of claim 12, further comprising
providing for display a second representation of the metadata comprising elements representing fields of a second database in the received information;
receiving a user selection of at least one second field in the second database;
providing second prescriptive metric options based on the contents of the at least one selected second field;
receiving second instructions for creating the prescriptive metric responsive to the second prescriptive metric options;
wherein generating a script to create the prescriptive metric based on the first instructions comprises generating the script to create a prescriptive metric based on the first instructions and the second instructions.

14. The method of claim 1, further comprising
providing for display a list of supplementary sources of information;
receiving a user selection of at least one supplementary source of information; and
wherein generating a script comprises generating a script to include the selected at least one supplementary source of information in the resulting information provided to the trait-based modeling system.

15. A system for onboarding client data comprising:
a memory device storing instructions;
at least one processor configured to execute the instructions to perform operations comprising:
receiving metadata on information received from one or more information sources;
receiving instructions for mapping the information onto a schema of a trait-based modeling system;
generating a script based on the received instructions; and
providing the script, wherein the resulting information is provided to the trait-based modeling system to optimize a field in the schema of the trait-based modeling system.

16. The system of claim 15, wherein the at least one processor is configured to execute the instructions to perform further operations comprising:
providing for concurrent display a first representation of the schema comprising objects representing fields of the trait-based modeling system displayed in an expandable list format, and a first representation of the metadata comprising objects representing databases in the received information displayed in an array;
receiving a user selection of one of the databases in the received information;
responsive to the user selection, providing for display a second representation of the metadata; and
wherein receiving instructions comprises receiving a user association between the first representation of the schema and the second representation of the metadata.

17. The system of claim 16, wherein:
the second representation of the metadata comprises elements representing fields of the selected database, and
the user association comprises the user selection of a field of the trait based modeling system, and a field of the selected database.

18. The system of claim 16, wherein the objects representing databases in the received information comprise an indication of a quality of the database.

19. The system of claim 17, wherein the elements representing the fields of the selected database comprise i) at least one indication of the content of the field, and ii) an indication of a quality of the field.

20. The system of claim 17, wherein generating a script comprises generating a script to optimize the selected field using the trait-based modeling system.

21. The system of claim 17, wherein generating a script comprises generating a script to perform natural language processing on the contents of the selected field using the trait-based modeling system.

22. The system of claim 15, wherein the at least one processor is configured to execute the instructions to perform further operations comprising:
providing for display a first representation of the schema comprising objects representing fields of the trait-based modeling system displayed in an expandable list format;
receiving a user selection of an object in the first representation representing a first field of the trait-based modeling system; and
responsive to the user selection, providing for display a first representation of the metadata including at least one indication of the relevance of the metadata to the first field of the trait-based modeling system.

23. The system of claim 15, wherein the at least one processor is configured to execute the instructions to perform further operations comprising:
providing for display a representation of the metadata comprising elements representing fields of a database in the received information;
receiving a user selection of a field of the database to filter;
responsive to the user selection, providing for display filtering options based on the contents of the selected field;
receiving user instructions for filtering the selected field based on the filtering options; and
wherein generating a script comprises generating a script to filter the selected field of the database.

24. The system of claim 15, wherein the at least one processor is configured to execute the instructions to perform further operations comprising:
providing for display a first representation of the metadata comprising elements representing fields of a first database in the received information;
receiving a user selection of a field of the first database as a first merger field;
responsive to the user selection of the first merger field, providing for display a second representation of the metadata comprising elements representing fields of a second database in the received information;
receiving a user selection of a second field in the second database as a second merger field corresponding to the first merger field,
responsive to the user selection of the second merger field, providing for display an indication of a connection between the first database and the second database; and
wherein generating a script comprises generating a script to create a third database by merging the first database and the second database by the first merger field and the second merger field.

25. The system of claim 15, wherein the second representation of the metadata indicates suitable merger fields, based on the selection of the first merger field.

26. The system of claim 15, wherein the at least one processor is configured to execute the instructions to perform further operations comprising;
providing for display a first representation of the metadata comprising elements representing fields of a first database in the received information;
receiving a user selection of at least one first field in the first database;
providing first prescriptive metric options based on the contents of the selected at least one first field;
receiving first instructions for creating the prescriptive metric responsive to the first prescriptive metric options;
wherein generating a script comprises generating a script to create the prescriptive metric based on the first instructions and to include the prescriptive metric in the resulting information provided to the trait-based modeling system.

27. The system of claim 26, wherein the at least one processor is configured to execute the instructions to perform further operations comprising:
providing for display a second representation of the metadata comprising elements representing fields of a second database in the received information;
receiving a user selection of at least one second field in the second database;
providing second prescriptive metric options based on the contents of the at least one selected second field;
receiving second instructions for creating the prescriptive metric responsive to the second prescriptive metric options;
wherein generating a script to create the prescriptive metric based on the first instructions comprises generating the script to create a prescriptive metric based on the first instructions and the second instructions.

28. The system of claim 15, wherein the at least one processor is configured to execute the instructions to perform further operations comprising:
providing for display a list of supplementary sources of information;
receiving a user selection of at least one supplementary source of information; and
wherein generating a script comprises generating a script to include the selected at least one supplementary source of information in the resulting information provided to the trait-based modeling system.

29. A non-transitory computer-readable storage medium storing instructions that, when executed by a processor, cause the processor to perform operations comprising:
receiving metadata on information received from one or more information sources;
receiving instructions for mapping the information onto a schema of a trait-based modeling system;
generating a script based on the received instructions; and
providing the script, wherein the resulting information is provided to the trait-based modeling system to optimize a field in the schema of the trait-based modeling system.

30. The non-transitory computer-readable storage medium of claim 29, wherein the medium stores further instructions that, when executed by the processor, cause the processor to perform operations comprising:
providing for concurrent display a first representation of the schema comprising objects representing fields of the trait-based modeling system displayed in an expandable list format, and a first representation of the metadata comprising objects representing databases in the received information displayed in an array;
receiving a user selection of one of the databases in the received information;
responsive to the user selection, providing for display a second representation of the metadata; and
wherein receiving instructions comprises receiving a user association between the first representation of the schema and the second representation of the metadata.

31. The non-transitory computer-readable storage medium of claim 30, wherein:
the second representation of the metadata comprises elements representing fields of the selected database, and
the user association comprises the user selection of a field of the trait based modeling system, and a field of the selected database.

32. The non-transitory computer-readable storage medium of claim 30, wherein the objects representing databases in the received information comprise an indication of a quality of the database.

33. The non-transitory computer-readable storage medium of claim 30, wherein the elements representing the fields of the selected database comprise i) at least one indication of the content of the field, and ii) an indication of a quality of the field.

34. The non-transitory computer-readable storage medium of claim 30, wherein generating a script comprises generating a script to optimize the selected field using the trait-based modeling system.

35. The non-transitory computer-readable, storage medium of claim 30, wherein generating a script comprises generating a script to perform natural language processing on the contents of the selected field using the trait-based modeling system.

36. The non-transitory computer-readable storage medium of claim 29, wherein the medium stores further instructions that, when executed by the processor, cause the processor to perform operations comprising:
providing for display a first representation of the schema comprising objects representing fields of the trait-based modeling system displayed in an expandable list format;
receiving a user selection of an object in the first representation representing a first field of the trait-based modeling system; and
responsive to the user selection, providing for display a first representation of the metadata including at least one indication of the relevance of the metadata to the first field of the trait-based modeling system.

37. The non-transitory computer-readable storage medium of claim 29, wherein the medium stores further instructions that, when executed by the processor, cause the processor to perform operations comprising:
providing for display a representation of the metadata comprising elements representing fields of a database in the received information;
receiving a user selection of a field of the database to filter;
responsive to the user selection, providing for display filtering options based on the contents of the selected field;
receiving user instructions for filtering the selected field based on the filtering options; and
wherein generating a script comprises generating a script to filter the selected field of the database.

38. The non-transitory computer-readable storage medium of claim 29, wherein the medium stores further instructions that, when executed by the processor, cause the processor to perform operations comprising:
providing for display a first representation of the metadata comprising elements representing fields of a first database in the received information;
receiving a user selection of a field of the first database as a first merger field;
responsive to the user selection of the first merger field, providing for display a second representation of the metadata comprising elements representing fields of a second database in the received information;
receiving a user selection of a second field in the second database as a second merger field corresponding to the first merger field,
responsive to the user selection of the second merger field, providing for display an indication of a connection between the first database and the second database; and
wherein generating a script comprises generating a script to create a third database by merging the first database and the second database by the first merger field and the second merger field.

39. The non-transitory computer-readable storage medium of claim 29, wherein the second representation of the metadata indicates suitable merger fields, based on the selection of the first merger field.

40. The non-transitory computer-readable storage medium of claim 29, wherein the medium stores further instructions that, when executed by the processor, cause the processor to perform operations comprising:
providing for display a first representation of the metadata comprising elements representing fields of a first database in the received information;
receiving a user selection of at least one first field in the first database;
providing first prescriptive metric options based on the contents of the selected at least one first field;
receiving first instructions for creating the prescriptive metric responsive to the first prescriptive metric options;
wherein generating a script comprises generating a script to create the prescriptive metric based on the first instructions and to include the prescriptive metric in the resulting information provided to the trait-based modeling system,

41. The non-transitory computer-readable storage medium of claim 40, wherein the medium stores further instructions that, when executed by the processor, cause the processor to perform operations comprising:
providing for display a second representation of the metadata comprising elements representing fields of a second database in the received information;
receiving a user selection of at least one second field in the second database;
providing second prescriptive metric options based on the contents of the at least one selected second field;
receiving second instructions for creating the prescriptive metric responsive to the second prescriptive metric options;
wherein generating a script to create the prescriptive metric based on the first instructions comprises generating the script to create a prescriptive metric based on the first instructions and the second instructions.

42. The non-transitory computer-readable storage medium of claim 29, wherein the medium stores further instructions that, when executed by the processor, cause the processor to perform operations comprising:
providing for display a list of supplementary sources of information;
receiving a user selection of at least one supplementary source of information; and
wherein generating a script comprises generating a script to include the selected at least one supplementary source of information in the resulting information provided to the trait-based modeling system.
